(19) United States
(12) Patent Application Publication
(10) Pub. No.: US 2005/0275751 A1
(43) Pub. Date: Dec. 15, 2005

(54) SECURITY COVER

(75) Inventor: Daniel J. VanEpps, Jr., Apex, NC (US)

Correspondence Address: MOORE & VAN ALLEN PLLC, P.O. BOX 13706, Research Triangle Park, NC, 27709, US

(73) Assignee: SONY ERICSSON MOBILE COMMUNICATIONS AB, Lund (SE)

(21) Appl. No.: 10/710,005

(22) Filed: Jun. 11, 2004

(51) Int. Cl. H04N 5/225; G03B 17/00

(52) U.S. Cl. 348/376

(57) ABSTRACT

An apparatus is provided for securing a mobile terminal including a housing and an imaging device disposed within the housing for capturing an image through a lens. The securing apparatus comprises a sheet having an upper surface and a lower surface and an adhesive applied on the lower surface of the sheet. The sheet may be releasably adhered to the surface of the mobile terminal for covering the lens to substantially prevent image capture by the imaging device.

### BACKGROUND OF INVENTION

This invention relates generally to a security device for a mobile communication device, and more particularly to a security device for a mobile terminal used in a wireless communication system wherein the mobile terminal includes a camera for capturing images and the security device selectively secures the camera against use.

A mobile terminal is used in a wireless communication system for sending and receiving information, such as a mobile telephone in a cellular telephone system. A mobile telephone typically includes a display and input mechanisms, such as keypads, buttons, and the like, which are used to control the mobile telephone. The display is used for viewing information and the input mechanisms typically provide for data entry, as well as control of any multi-media interface including the display. With their growing popularity, mobile telephones are being used as receivers for not only voice data, but also various forms of visual data viewable on the display, such as e-mail, faxes or other forms of processed documents, pictures, videos or web pages.

Some mobile telephones now also include a camera function for satisfying the rising demand for video or image-based communication. In a typical mobile telephone with a camera, the camera is mounted inside the housing of the phone. An opening is provided in the surface of the housing for the camera lens. The display can be used to target the lens, or a viewfinder is provided. A user will use the camera function by looking into the display or view finder and actuating a shutter release to capture an image. The camera includes means for transmitting an image signal to a main controller in the phone.

Unfortunately, mobile telephones with a camera function can be misused. An example of misuse which is of particular concern is corporate espionage. As a result, some businesses do not allow visitors to carry mobile telephones with a camera function in its buildings. However, this can be a serious impediment to the phone user who requires the phone function. For those businesses that do allow visitors to carry mobile telephones, it is important for security personnel to have a simple means to secure the camera function against use and to determine whether the camera was used to deter visitors from attempting to steal company secrets.

For the foregoing reasons, there is a need for an effective device for securing mobile telephones with a camera function against use while allowing the phone function. Ideally, the security device should also allow security personnel to readily determine whether there has been an attempt to use the secured camera function. The new security device should be inexpensive to manufacture and simple to use.

### SUMMARY OF INVENTION

According to the present invention, an apparatus is provided for securing a mobile terminal including a housing and an imaging device disposed within the housing for capturing an image through a lens. The securing apparatus comprises a sheet having an upper surface and a lower surface and an adhesive applied on the lower surface of the sheet, wherein the sheet may be releasably adhered to the surface of the mobile terminal for covering the lens to substantially prevent image capture by the imaging device.

Also according to the present invention, a mobile terminal is provided for use in a wireless communication system. The mobile terminal comprises a housing, an imaging device disposed within the housing for capturing an image through a lens, a sheet having an upper surface and a lower surface, and an adhesive applied on the lower surface of the sheet. The sheet may be releasably adhered to the surface of the mobile terminal for covering the lens to substantially prevent image capture by the imaging device.

Further according to the present invention, a method is provided for securing a mobile terminal including a housing and an imaging device disposed within the housing for capturing an image through a lens. The securing method comprises providing a security cover comprising a sheet having an upper surface and a lower surface, and an adhesive applied on the lower surface of the sheet, and releasably adhering the sheet to the mobile terminal for covering the lens to substantially prevent image capture by the imaging device.

### BRIEF DESCRIPTION OF DRAWINGS

For a more complete understanding of the present invention, reference should now be had to the embodiments shown in the accompanying drawings and described below. In the drawings:

FIG. 1 is an elevation schematic view of an exemplary mobile terminal including a camera function;

FIG. 2 is a plan view of a security cover according to the present invention;

FIG. 3 is cross-section of the security cover shown in FIG. 2 taken along 3-3 of FIG. 2; and

FIG. 4 is a close up view of the security cover shown in FIG. 2 in place over the lens of the mobile terminal shown in FIG. 1.

### DETAILED DESCRIPTION

Certain terminology is used herein for convenience only and is not to be taken as a limitation on the invention. For example, words such as “upper,” “lower,” “left,” “right,” “horizontal,” “vertical,” “upward,” and “downward” merely describe the configuration shown in the FIGs. Indeed, the components may be oriented in any direction and the terminology, therefore, should be understood as encompassing such variations unless specified otherwise.

As used herein, the term “camera” is used to mean an imaging device usually provided with an optical lens, or system of lenses, through which light from an object passes and forms an image, usually on a light-sensitive medium. The term “camera” includes an imaging device wherein an image is captured as a still picture, or a series of images are captured as in a movie camera or video camera.

In an embodiment of the present invention shown in the FIGs., a security cover is depicted for use with a mobile communication device, such as a mobile terminal used in a wireless communication system for sending and receiving information, including a mobile telephone in a cellular telephone system. The mobile terminal includes a camera for capturing images.

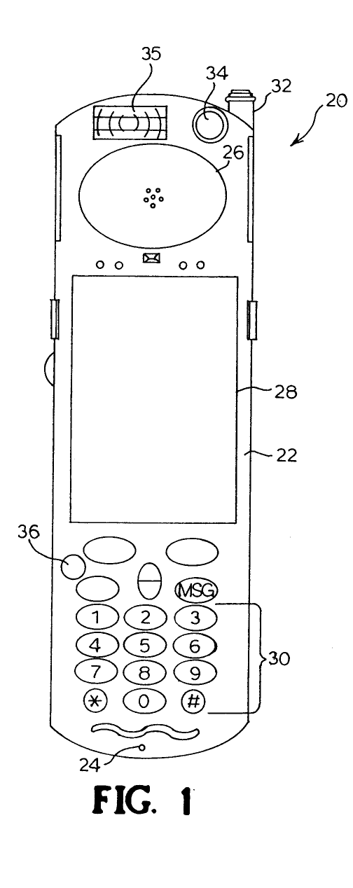

Referring now to the drawings, wherein like reference numerals designate corresponding or similar elements throughout the several views, a mobile terminal according to the present invention is shown in FIG. 1 and generally designated at 20. The mobile terminal 20 is adapted for use in a wireless communication network and, in the embodiment shown in FIG. 1, the mobile terminal 20 is a cellular telephone, which may be conventional except as otherwise provided in this description. The mobile terminal 20 comprises a housing 22 which may be of any desired size and shape. The housing 20 contains electronic components that are operable to transmit and receive telecommunication signals, as is known in the art. Because there are many types of mobile terminal housings and associated components that are well known in the art and that may be utilized to practice the present invention, a more detailed description of these components is not required. It is understood that the present invention is not directed to any particular style of housing.

The housing 22 includes a mouthpiece 24 for inputting sound, an earpiece 26 for receiving sound, a display 28, and a key pad 30 with standard alphanumeric keys such as are found on many conventional mobile terminals. An extendible antenna 32 transmits and receives data over the wireless communication network. In keeping with the present invention, a camera function is provided within the housing 22. The housing 22 defines openings for a lens 34 and a flash 35 of the camera (not shown). A shutter release button 36 is provided for actuating the camera. It is understood that the lens 34 and shutter release button 36 can be positioned in many different locations, including the rear wall of the housing 22. Various other controls may also be provided on the mobile terminal 20, some of which are used with features of the mobile terminal 20.

According to another embodiment of the present invention, the mobile terminal 20 may include a cover (not shown), also referred to as a “flip” or “flip cover”, pivotally mounted to the housing 22 by a hinge. The cover is moveable between an open position and a closed position. In the open position, the display 28 and keypad 30 are visible and accessible to a user. In the closed position, the display 28 and keypad 30 are substantially covered by the cover. A sensor may be provided within the housing 22 for sensing the position of the cover. The sensor enables the mobile terminal 20 to answer individual calls upon opening the terminal cover, as is known in the art.

A main processor and a memory control the overall operation of the mobile terminal 20 and are together referred to herein as a “controller”, as is known in the art. The camera 30 is electrically connected to the controller for sending and receiving image data. To facilitate the description, it is henceforth assumed that aspects of the present invention are generally carried out through the execution of software instructions in the mobile terminal 20. It is envisioned that these instructions may be written in the Java language or, alternatively, in C or C++. Note, however, that other languages may be substituted within the scope of the present invention. As is well known, Java is an application designed specifically for network connectable applications on consumer devices. The details of developing software in Java is well known to those skilled in the relevant art and are not required for an understanding of the present invention. Accordingly, such details are not provided herein. Certain embodiments of the present invention may be carried out by hardwired circuitry rather than by executing software, or by a combination of hardwired circuitry with software. Hence, it will be recognized that the present invention is not limited to any specific combination of hardware circuitry and software, nor to any particular source for software instructions.

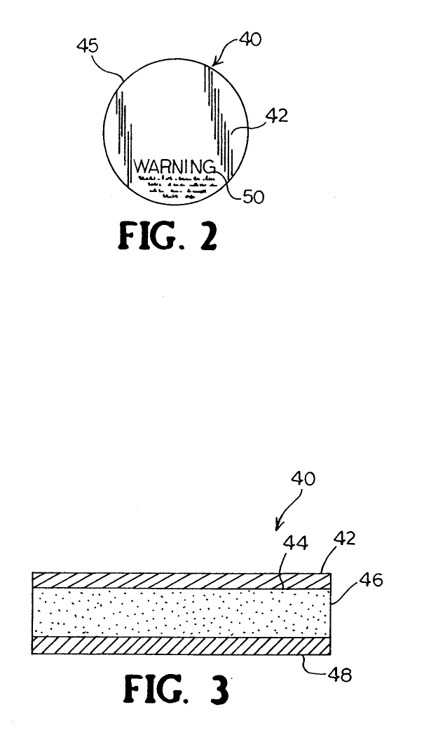

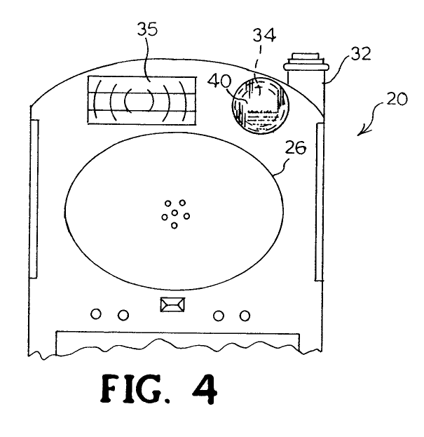

Referring now to FIG. 2, a security cover for securing a camera function of a mobile terminal 20 against use according to the present invention is shown and generally designated at 40. The security cover 40 is a thin, annular element having substantially planar top surface 42 and a bottom surface 44 (FIG. 3). The shape of the security cover 40 as depicted in FIG. 1 is circular, although the shape is not critical in practice of the present invention and may conveniently be rectangular, oval, triangular, etc. The security cover 40 may comprise a soft, flexible material which allows the cover to conform to any curvature of the surface of the housing 22 or lens 34 of the mobile terminal 20. Thus, the base curvature of the housing 22 or lens 34 may vary without affecting the use of the present invention. The security cover 40 is preferably formed from an opaque material. The security cover 40 could also comprise a reflective film which, as will be described below, would prevent useful pictures from being taken by a user of the mobile terminal.

The bottom surface 44 of the security cover 40 includes a layer of adhesive material 46 for removably adhering the security cover to the housing 22 or lens 34 of the mobile terminal 20. Many types of adhesive 46 are suitable for use with the security cover 40 according to the present invention, as long as the adhesive 46 allows firm bonding of the cover to the mobile terminal 20. The adhesive 46 must also allow easy removal of the security cover 40 following use. The adhesive 46 is preferably a pressure sensitive adhesive applied to the bottom surface 44 of the security cover 40. A wide variety of such adhesives are commercially available. In one embodiment of the present invention, a portion of the edge of the bottom surface 44 of the security cover 40 may be devoid of adhesive 46 to prevent that portion of the cover 40 from adhering to the mobile terminal 20. This provides a location for users to grasp the security cover 40 for removing the cover from the housing 22 or lens 34. The adhesive material 46 preferably does not leave any residue on the mobile terminal 20 when removed.

The security cover 40 may be any size sufficient to cover the lens 34, as well as furnish an adhesive coated area large enough to provide a firm bond between the security cover 40 and the housing 22 or lens 34. However, the security cover 40 should not be so large as to extend beyond the area of the lens 34 so as to effect the phone function of the mobile terminal 20. In one embodiment, the security cover 40 may have an outer perimeter larger than the outer perimeter of the lens 34 so the security cover 40 will cover the lens 34 when the security cover 40 is placed over the lens 34. As an alternative in this embodiment, only an edge region of the bottom surface 44 of the security cover 40 may be coated with the adhesive material 46.

The security cover 40 may further comprise a protective backing 48 removably adhered to the bottom surface 44 of the cover over the adhesive 46 layer. The removable protective backing 48 prevents adhesion of the security cover 40 to undesired surfaces prior to use. Protective backings 48 are well known in the art and typically comprise a variety of materials such as paper treated with a release agent such as silicone, or alternatively a conformable material, for example, polyethylene, polyvinyl chloride, and the like. The removable protective backing 48 may be the same size and shape as the security cover 40 or may be larger. In the embodiment of the present invention described above, wherein the security cover 40 has a portion of the edge without adhesive 46, the user may grasp that portion for easily removing the backing 48 from the security cover 40.

In use, the protective backing 48 is manually removed from bottom surface 44 of the security cover 40 exposing the adhesive 46. The security cover 40 is now ready to be affixed to the mobile terminal 20. The security cover 40 is then positioned on the housing 22 over the lens 34 so that the lens 34 is substantially covered by the security cover 40. Once positioned, pressure is applied so that the security cover 40 is adhesively conformed to the surface of the housing 22 and lens 34.

Further according to the present invention, once secured in place over the camera lens 34, the security cover 40 will enable security personnel to detect whether a user has removed the security cover 40 from the mobile terminal 20 and attempted to replace the security cover 40, presumably in an attempt to obtain unauthorized pictures. In other words, the security cover 40 provides an effective means of securing the camera function of the mobile terminal 20 against use by eliminating the possibility of removal and re-affixing of the security cover 40 by providing a means for indicating removal or tampering with the cover.

According to the present invention, the security cover 40 can resist efforts to defeat a security system including the cover 40 because of structure that can offer a combination of transfer-inhibiting and counterfeit-inhibiting features. For example, the security cover 40 could be adapted to be capable of only a one-time application such that the adhesion of the security cover 40 is not sufficient to reattach the cover to the mobile terminal 20 once it has been removed.

Similarly, a security cover 40 adapted to be destroyed upon removal is also in keeping with the present invention. For example, the security cover 40 may be comprised of a material having low tear propagation resistance. In combination with a relatively strongly adhering adhesive 46, the security cover 40 is irreversibly destroyed when removed from a surface. More specifically, if removal of the security cover 40 from the mobile terminal 20 is attempted, part of the material comprising the cover will remain on the housing 22 or lens 34. The damage to the security cover 40 would preferably be readily apparent to the human eye, thus it will be clear to security personnel that the security cover 40 has been tampered with. A suitable a security cover according to this embodiment of the present invention is shown in U.S. Pat. No. 4,268,983, the contents of which are hereby incorporated by reference, which describes an adhesive label comprising a support sheet and a fragile, easily tearable film adhered to the support sheet. If the label according to the ″983 patent is removed from an article to which it has been applied, a portion of the fragile film comprising the label will tear and remain adhered to the substrate. Tearing of the label prevents re-use of the label since reapplication of the label with a portion missing would reveal the transfer.

Another embodiment of a security cover 40 according to the present invention will permanently stretch and wrinkle when pulled thereby indicating tampering and attempted removal.

U.S. Pat. No. 4,184,701, the contents of which are hereby incorporated by reference, describes a suitable security cover 40 which is constructed from a plurality of colored layers which exhibit little adhesion to one another. In combination with a relatively strongly adhering adhesive 46 on the bottom surface 44 of the cover 40, such layers irreversibly separate from one another when removed, thereby indicating the removal of the security cover 40.

In another embodiment of a security cover 40 according to the present invention, when the security cover 40 is removed a mark, a blotch, or clear area may appear on the security cover 40, or a mark different in color from the surface of the mobile terminal 20 may remain on the mobile terminal 20, thereby providing an indication of removal of the cover 40. In U.S. Pat. No. 6,047,991, which is hereby incorporated by reference, a security cover is described which comprises a computer imprintable matte top-coated metallicized polyester film, backed with a semi-bleached craft release liner which is coated on one side with adhesive. If removal is attempted, a fracturing of a polyester/metal bond results, leaving a pattern on the item to which it is adhered.

The security cover 40 can also be adapted to leave some form of indicia on a surface, such as the mobile terminal housing 22, when removed. U.S. Pat. No. 5,358,281, the contents of which are hereby incorporated by reference, describes an adhesive label which leaves components of the label on the surface, including visible indicia, when removed. The removable portion of the label is no longer adhesive once removed. As described in the ″991 patent referenced above, the indicia left behind on the surface may be alphanumeric characters which spell out words indicating a problem situation, for example, the word “void”, “fraud”, “danger”, and the like. U.S. Pat. No. 4,121,003, the contents of which are hereby incorporated by reference, also describes the transfer of alphanumeric characters upon removal of a security label, wherein the characters comprise a material of low cohesion which, when the adhesive security label is detached from a surface, the label splits within itself and remains in part on the surface to which it is adhered.

U.S. Pat. No. 5,633,058, the contents of which are hereby incorporated by reference, describes transparent printed indicia anchored weakly to a backing film which is covered with a full area colored layer which anchors well to the backing film and to the printed indicia. The colored layer is coated with a self-adhesive composition. When an adhesive security cover of this type is peeled from a surface, the transparent printed indicia parts from the film surface together with the color layer and the adhesive composition and remains as writing on the surface.

U.S. Pat. Nos. describe 6,537,634 and 6,544,615, the contents of which are hereby incorporated by reference, describe multi-layer adhesive tape having a backing based on an oriented thermoplastic film coated on one side with an adhesive composition. The adhesive tape indicates the unauthorized removal when, on peeling from the surface to which it is stuck, areas of the adhesive tape are extracted from the adhesive tape and remain on the surface as a message which is imperceptible prior to detachment of the tape from the surface. Following detachment, the message remains visible even if the adhesive tape is replaced exactly at the original bond site so that the evidence of manipulation ‘remains perceptible. In the ″615 patent, the identical writing is visible in inverted form on the peeled off film backing.

A latent retroreflective image could also be applied to the security cover 40. A latent retroreflective image is an image that is not generally visible under diffused light viewing conditions, such as ordinary daylight or in a lighted room. The image is viewable in retroreflective viewing conditions, wherein light is beamed at the label and an observer views the label from a position substantially coaxial with the beam of light. A variety of ways to provide latent retroreflective images for use in authenticating documents are taught in U.S. Pat. Nos. 3,801,183 and 4,099,383, which are incorporated herein by reference. The preferred way is by use of an image-bearing dielectric mirror disposed behind a layer of microspheres as generally described in U.S. Pat. No. 3,700,305 which is incorporated herein by reference.

A variety of other means to make a label difficult to counterfeit have been developed, as illustrated by such patents as U.S. Pat. No. 1,003,443 (a label comprising two overlaid films, each of which carries a portion of a complete design and removal of one film reveals transfer); U.S. Pat. No. 1,825,796 (special printable papers made with an identifying marking that is visible only with transmitted light); U.S. Pat. No. 3,864,855 (tamper proof label comprising a fragile label base in a protective overlay film which is removed after application of the label leaving just the difficult to transfer label base); U.S. Pat. No. 3,925,584 (sealing tape comprising a thinly fragile material which carries on one surface a strong adhesive layer by which the tape is adhered to an article and on its other surface a weak adhesive layer by which a support sheet is weakly adhered to the assembly); and U.S. Pat. No. 4,082,873 (laminated label comprising a transparent film having printing on its reverse side and an adhesive layer to which the printing adheres more strongly than it adheres to the transparent film), the contents of all of which are hereby incorporated by reference.

Also according to the present invention, printed information indicia 50 may appear on the upper surface 42 of the security cover 40 as seen in FIG. 2. The printed information indicia 50 can include alphanumeric characters, which may provide a warning to the phone user to prevent tampering with the security cover 40. For example, a warning message could read as follows: “Warning, this is a security cover. User must surrender phone if cover is altered, removed or tampered with.” With the security cover 40 featuring a printed warning, a user cannot persuasively claim that an attempt to remove the security cover 40 was inadvertent. The indicia may further, or in the alternative, comprise an automatic identification technology, such as bar coding, which can be scanned and entered into a computer. In this way, the secured mobile terminal 20 may be efficiently identified with a particular user and tracked, and duplication would be difficult.

Printed information 50 would most typically be applied to the security cover 40 by a printing operation while the cover is carried on the backing 48. The indicia 50 may be applied by ink jet printing, plate printing or the like. Suitable flexible or lithographic inks available from a wide variety of suppliers can also be used to print the indicia 50 using contact printing methods. The printed information indicia 50 could also be a sensible background component comprising, for example, a visible or machine-sensed component such as a printed graphic image extending over its area. When a tearable security cover 40 carries an image, removal or tampering would be revealed since it is unlikely that the image on the cover 40 will survive removal. U.S. Pat. No. 127,663, the contents of which are hereby incorporated by reference, describes an adhesive label having printed matter on its adhesive side so that the label cannot be removed without defacing the printed matter.

The security cover 40 according to the present invention provides a temporary, tamper-proof cover placed over a lens 34 of a mobile terminal 20 with a camera function. The security cover 40 provides security against unauthorized pictures and reliable evidence that the camera function has been used. Any attempt at removal or tampering is identified by any of the means for irreversibly indicating removal or tampering described above. The security cover 40 allows the user to continue to use the phone function, but the user is unable to produce usable pictures with the security cover 40 in place. Even if the user effectively claims that removal of the security cover 40 was inadvertent, the security cover 40 alerts security personnel to the possibility of unauthorized use and establishes the need to check the items in the camera.

While the present invention is described herein in the context of the mobile terminal in the form of a mobile cellular telephone, it should be understood that the security cover of the present invention is not so limited and may find utility in other electronics devices and applications that include a camera function. For example, the term “mobile telephone” as used herein may include a cellular radiotelephone with or without a multi-line display; landline and cordless telephones; a Personal Communications System (PCS) terminal that may combine a cellular telephone with data processing, facsimile and data communications capabilities; a Personal Digital Assistant (PDA) that can include a radiotelephone, pager, Internet/intranet access, Web browser, organizer, calendar and/or a global positioning system (GPS) receiver; wristwatch keypad devices; and a conventional laptop and/or palmtop receiver or other computer system that includes a display. Mobile telephones may also be referred to as “pervasive computing” devices. In one embodiment of the present invention, the invention may be implemented on a computer system having a memory circuit for storage of data, a display which acts to generate images, and a control circuit that is configured to control the flow of data between the memory and receiver.

Although the present invention has been shown and described in considerable detail with respect to only a few exemplary embodiments thereof, it should be understood by those skilled in the art that I do not intend to limit the invention to the embodiments since various modifications, omissions and additions may be made to the disclosed embodiments without materially departing from the novel teachings and advantages of the invention, particularly in light of the foregoing teachings. For example, the present invention is suitable for use in a number of portable and non-portable electronics devices and applications. Accordingly, we intend to cover all such modifications, omission, additions and equivalents as may be included within the spirit and scope of the invention as defined by the following claims. In the claims, means-plus-function clauses are intended to cover the structures described herein as performing the recited function and not only structural equivalents but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures.

1. An apparatus for securing a mobile terminal including a housing and an imaging device disposed within the housing for capturing an image through a lens, the securing apparatus comprising:
a sheet having an upper surface and a lower surface; and
an adhesive applied on the lower surface of the sheet, wherein the sheet may be releasably adhered to the surface of the mobile terminal for covering the lens to substantially prevent image capture by the imaging device.

2. A securing apparatus as recited in claim 1, wherein the sheet is formed from an opaque material.

3. A securing apparatus as recited in claim 1, wherein the lower surface of the sheet comprises a reflective surface.

4. A securing apparatus as recited in claim 1, wherein the sheet is selected from a film, paper, a woven fabric, or a non-woven fabric.

5. A securing apparatus as recited in claim 1, wherein the adhesive is a pressure-sensitive adhesive.

6. A securing apparatus as recited in claim 1, wherein the lower surface of the sheet is partially covered with adhesive.

7. A securing apparatus as recited in claim 6, wherein the partial adhesive coverage includes the periphery of the lower surface of the sheet.

8. A securing apparatus as recited in claim 6, wherein the partial adhesive coverage includes all but a portion of the lower surface of the sheet, the portion of the sheet without adhesive being adjacent to the edge of the sheet.

9. A securing apparatus as recited in claim 1, further comprising a protective backing for removably covering the lower surface of the sheet.

10. A securing apparatus as recited in claim 1, further comprising indicia on the upper surface.

11. A securing apparatus as recited in claim 10, wherein the indicia comprise characteristic symbols.

12. A securing apparatus as recited in claim 10, wherein the indicia comprise alphanumeric characters

13. A securing apparatus as recited in claim 10, wherein the indicia are machine-readable.

14. A securing apparatus as recited in claim 13, wherein the machine-readable indicia is a latent retroreflective image.

15. A securing apparatus as recited in claim 1, wherein the sheet is altered upon removal.

16. A securing apparatus as recited in claim 15, wherein the adhesive does not retain its adhesiveness upon removal from the mobile terminal housing or lens such that the sheet cannot be re-applied once removed.

17. A securing apparatus as recited in claim 15, wherein the alteration of the sheet includes irreversible destruction of the sheet upon removal.

18. A securing apparatus as recited in claim 17, wherein the sheet is formed from an easily tearable material.

19. A securing apparatus as recited in claim 17, wherein upon removal of the sheet from the mobile terminal housing or lens, a portion of the sheet will tear from the remainder of the sheet and the portion will remain adhered to the mobile terminal or lens.

20. A securing apparatus as recited in claim 19, wherein the portion of the sheet adhered to the mobile terminal or lens comprises indicia.

21. A securing apparatus as recited in claim 20, wherein the indicia comprises alphanumeric characters.

22. A mobile terminal for use in a wireless communication system, comprising:
a housing;
an imaging device disposed within the housing for capturing an image through a lens, the housing defining an opening for the lens;
a sheet having an upper surface and a lower surface; and
an adhesive applied on the lower surface of the sheet, wherein the sheet may be releasably adhered to the surface of the mobile terminal for covering the lens to substantially prevent image capture by the imaging device.

23. A mobile terminal as recited in claim 22, wherein the mobile terminal is a cellular telephone.

24. A mobile terminal as recited in claim 22, wherein the mobile terminal is used in a wireless communication system.

25. A mobile terminal as recited in claim 22, wherein the imaging device is a camera.

26. A mobile terminal as recited in claim 22, wherein the adhesive has a greater affinity for the sheet than for the surface of the mobile terminal or lens to which it is to be applied.

27. A mobile terminal as recited in claim 22, further comprising a protective backing for removably covering the lower surface of the sheet.

28. A mobile terminal as recited in claim 22, further comprising indicia on the upper surface.

29. A mobile terminal as recited in claim 28, wherein the indicia comprise characteristic symbols

30. A mobile terminal as recited in claim 22, wherein the sheet is altered upon removal.

31. A mobile terminal as recited in claim 30, wherein the adhesive does not retain its adhesiveness upon removal from the mobile terminal housing or lens such that the sheet cannot be re-applied once removed.

32. A mobile terminal as recited in claim 30, wherein the alteration of the sheet includes irreversible destruction of the sheet upon removal.

33. A mobile terminal as recited in claim 22, wherein the adhesive is a pressure-sensitive adhesive for producing a bond between the sheet and the housing of the mobile terminal or the lens.

34. A method for securing a mobile terminal including a housing and an imaging device disposed within the housing for capturing an image through a lens, the securing method comprising:
providing a security cover comprising a sheet having an upper surface and a lower surface, and an adhesive applied on the lower surface of the sheet; and
releasably adhering the sheet to the mobile terminal for covering the lens to substantially prevent image capture by the imaging device.

35. A securing method for a mobile terminal as recited in claim 34, further comprising the steps of providing a protective backing for removably covering the lower surface of the sheet, and removing the backing prior to the releasably adhering step.

36. A securing method for a mobile terminal as recited in claim 34, wherein the releasably adhering step comprises adhesively attaching the sheet to the lens.

37. A securing method for a mobile terminal as recited in claim 34, wherein the releasably adhering step comprises adhesively attaching the sheet to the housing.
